(19) United States
(12) Patent Application Publication
(10) Pub. No.: US 2007/0289274 A1
(43) Pub. Date: Dec. 20, 2007

(54) Nestable, low-cost, planar air filter frame

(76) Inventors: Thomas A. Justice, (US); James B. Mercer, (US)

Correspondence Address: NIXON PEABODY, LLP, 401 9TH STREET, NW, SUITE 900, WASHINGTON, DC, 20004-2128, US

(21) Appl. No.: 11/453,988

(22) Filed: Jun. 16, 2006

(51) Int. Cl. B01D 46/00

(52) U.S. Cl. 55/511

(57) ABSTRACT

A nestable frame for planar air filters or other screen-like planar structures. The nestable frame provides all of the following desirable properties at once: 1. Simple manufacturing and assembly process, 2. Simple design, 3. Enhanced structural rigidity, 4. Significant space-savings during storage and transport, and 5. Simple handling. Preferably, the filter frame comprises an upper and a lower frame portion with a first leg each, where the peripheral edge of the filter media is clampingly engaged between the first leg of the upper frame portion and the first leg of the lower frame portion. From the first leg, the upper frame portion extends outwardly with at least two legs folded into a vertically flipped V. The lower frame portion may or may not have one additional second leg extending outwardly from the first leg, in parallel direction and intimately connected to the second leg of the upper frame portion. Alternative embodiments may contain additional corresponding and intimately connected legs in the upper and lower frame portions, so that the cross-sectional shape of the frame is varied. Further included in the present invention are manufacturing methods for the stackable frame.

### BACKGROUND OF THE INVENTION

1. Field of the Invention

The present invention relates generally to air filters and, more particularly, to a nestable frame for planar air filters or other screen-like planar structures.

2. Description of the Prior Art

Filters are typically provided in heating, ventilating and air conditioning equipment upstream of the air handler for removing particulate impurities from the air principally in order to protect the equipment, and secondarily to remove particulate impurities from the air circulated within homes, offices and industrial environments that affect the indoor air quality to which people are exposed. Such filters are also used for removing impurities entrained in air or another gas prior to release of the gas into the atmosphere. Various industrial processes also use filters for removing particulates from gases or other fluids.

Filters are typically formed by mounting a panel of a filter medium, such as a fibrous mat or porous foam or a pleated panel of a filter medium to reduce the relative pressure drop, within a surrounding support frame. The frame supports the filter medium in a relatively planar shape and provides mechanical strength for retaining the filter in a manner which is not only mechanically secure but also seals well to its associated machinery so that all of the fluid flow is directed through the filter medium.

It is desirable for a filter to be inexpensive and have sufficient strength and durability. It is also desirable to maximize the effective filtering area of a filter and to permit the compact packaging of multiple filters for efficient distribution and storage.

Generally, prior art in the field of air filters relates to three different types of devices:
a) filters with a box-like frame,
b) filters with a frame that is essentially incompressible, and
c) filters that consist of a frame that is compressible, collapsible or stackable, so that multiple filters can be stacked tightly during storage and transport prior to usage.

Relevant prior art to the present invention relates to type c) above.

A basic example of a stackable planar filter was disclosed in U.S. Pat. No. 3,970,440 issued Jul. 20, 1976, to Copenhefer, et al. for a Compact Air Filter. This basic planar air filter comprises a frame formed of an integral suitable cut and scored blank of paperboard, which, when assembled, comprises planar frame members engaging a substantially sheet-form filter element there between. Attached to the planar frame members, the disclosed frame has flared frame members disposed at an angle of less than 180 degree permitting a plurality of frames to nest within each other, thereby reducing the bulk of the plurality of filters. More sophisticated prior art subsequent to this patent is cited below with brief abstract statements summarizing the main points for each reference:

U.S. Pat. No. 4,068,071 issued Apr. 25, 1978, to Champlin, for an Air filter assembly, describes an air filter that contains a multisided supporting frame. The frame includes a foraminous center section, a marginal section delimiting the center section, and flanges connected to the marginal section. The center and marginal sections are in supporting engagement with one surface of the filter panel. The flange segments are foldably connected to the marginal sections and extend angularly inwardly therefrom forming an acute angle with the corresponding marginal sections. The construction of the frame enables the filter assembly to assume a collapsed state so that a plurality of such assemblies can form a compact bundle for shipping and/or storage.

U.S. Pat. No. 4,105,423 issued Aug. 8, 1978, to Latakas, et al. for a Compact air filter with tubular frame, describes a compact nestable air filter comprising a frame formed of an integral suitable cut and scored blank of paperboard. The assembled frame comprises planar frame members engaging a sheet-form filter element there between, and has flared frame members disposed at an angle of less than 180 degree permitting a plurality of completed filters to nest within each other, thereby reducing the bulk of the plurality of filters. The flared frame members have a tubular contour, greatly increasing their strength and rigidity.

U.S. Pat. No. 4,372,763 issued Feb. 8, 1983, to Champlin, et al. for an Air filter assembly, describes an air filter assembly comprising a compressible air pervious multi-sided filter panel and a frame therefor. The frame is adjustable from a collapsed mode to an operative mode. The frame of foldable sheet material includes a foraminous center section in supporting engagement with the filter panel; a marginal section delimiting the center section; and a plurality of elongated peripheral sections foldably connected to the marginal sections. The peripheral and the marginal sections form a hollow verge encompassing the filter panel periphery when the frame is in the operating mode. The peripheral sections form a substantially flat multiply flange overlapping and compressing the filter panel periphery when the frame is collapsed. When the frame is adjusted from the collapsed mode to the operating mode, the overlapped end portions of the peripheral sections will abuttingly engage at an angle and restrain movement of the frame from the operating mode back to the collapsed mode.

U.S. Pat. No. 4,636,233 issued Jan. 13, 1987, to Lizmore for a Filter assembly, describes a filter assembly including a casing with a support panel to support the filter element and upstanding walls extending around the periphery of the casing. The walls are inclined to the support panel to permit nesting of the casings during transport.

U.S. Pat. No. 5,800,588 issued Sep. 1, 1998, to Miller for a Nestable, rigid filter frame describes a filter with a nestable frame. The frame includes a first leg, a second leg extending obtusely from the first leg, and a third leg extending from the second leg and forming a channel between the second and third legs. The filter also includes a brace with similar first, second and third legs. The brace is mounted to the frame, with its second and third legs extending into the channel of the frame. A chamber is formed by the second and third legs of the frame and the second and third legs of the brace. The chamber is preferably filled with a material which strengthens the box beam structure formed by the walls surrounding the chamber. A filter medium material attaches to the frame, by adhesion and/or by clamping engagement between the first legs of the frame and brace.

U.S. Pat. No. 6,033,454 issued Mar. 7, 2000, to Hoefflken for an Air filter assembly, describes a filter frame with planar surfaces and rails along outer edges of the planar surfaces. The rails flare outwardly at an obtuse angle from the plane when the frame is unconfined One of the rails at each corner of the rectangular frame is provided with tabs, and the other rail at the corner has an open end into which the tab extends. The tabs are slidable to enable collapsing of the rails for transport but confined by their geometry to prevent disengagement of the rails when the frame is assembled.

None of the prior art provide a frame with all of the following desirable properties: 1) simple manufacturing and assembly process, 2) simple design, 3) enhanced structural rigidity, 4) significant space-savings during storage and transport, 5) simple handling, and 6) lower material handling and packaging costs. A combination of all these functionalities is desired because all simplicity aspects and space savings result in cost-savings, and structural rigidity of the frame is required for quality purposes.

Filter frames in prior art that provide for sufficient frame stability contain a tubular profile or a void as element required for the enhanced rigidity. Such voids make the frame more complex and are difficult to manufacture.

Filter frames in prior art with only one frame leg extending from the planar filter media are simple in design but do not provide sufficient rigidity.

Filter frames that can be stacked tightly in a collapsed mode and become rigid by unfolding them to the operating mode require additional attention after packaging and transport and therefor increase operating cost.

Thus, there remains a need for a stackable filter frame that is cost-efficient in manufacture and operation and simple in design, can be compactly stacked during storage and transport, and yet exhibits structural rigidity to provide a high-quality product.

### SUMMARY OF THE INVENTION

The present invention is directed to a planar, nestable air filter with several different frame geometries capable of providing a simple, low-cost, stable frame for planar air filter panels. The frames described are cost-effective in manufacturing, operation and raw materials, and allow for savings in storage and transportation cost since the volume is reduced significantly when several air filters are packaged together. In addition, the frame geometry provides sufficient rigidity to result in a high-quality filter.

In a preferred embodiment, the filter frame comprises an upper and a lower frame portion with a first leg each, where the peripheral edge of the filter media is clamped, adhered, stapled, or with other suitable means engaged between the first leg of the upper frame portion and the first leg of the lower frame portion. From the first leg, the upper frame portion extends outwardly with at least two legs forming a vertically flipped V. The lower frame portion may have one partial or full additional legs extending outwardly from the first leg, in parallel direction and intimately connected by suitable means such as adhesive to the first leg of the upper frame portion.

In an alternative embodiment, to decrease the frame's weight, there is no lower frame portion and the peripheral edge of the filter media is adhered, stapled, or otherwise engaged to the first leg of the upper frame portion.

In an alternative embodiment, the second and the third leg of the upper frame portion are connected by an additional leg inbetween, so that a structure similar to a vertically flipped U with opened outer legs is formed. The additional leg may be essentially straight or curved.

The present invention is further directed to a method for manufacture and assembly of the stackable frame. These and other aspects of the present invention will become apparent to those skilled in the art after a reading of the following description of a preferred embodiment when considered with the drawings.

### BRIEF DESCRIPTION OF THE DRAWINGS

FIG. 1 is a perspective illustration of a planar air filter comprising the nestable frame in a first preferred form of the invention.

FIG. 2 is a view in vertical section taken substantially along the line 2-2 of FIG. 1 illustrating a segment of the filter of FIG. 1.

FIG. 3 through 7 are views in section illustrating alternative filter frames embodying the present invention.

FIG. 8 through 13 are alternative frame designs to FIG. 2 through 7.

FIG. 14 through 19 are alternative frame designs to FIG. 2 through 7.

FIG. 20 is a view in vertical section taken substantially along the line 2-2 of FIG. 1, illustrating a plurality of stacked filters in a package.

### DETAILED DESCRIPTION OF THE PREFERRED EMBODIMENTS

In the following description, like reference characters designate like or corresponding parts throughout the several views. Also in the following description, it is to be understood that such terms as “forward,” “rearward,” “front,” “back,” “right,” “left,” “upwardly,” “downwardly,” “horizontal,” “vertical,” and the like are words of convenience and are not to be construed as limiting terms.

Referring now to the drawings in general, the illustrations are for the purpose of describing a preferred embodiment of the invention and are not intended to limit the invention thereto.

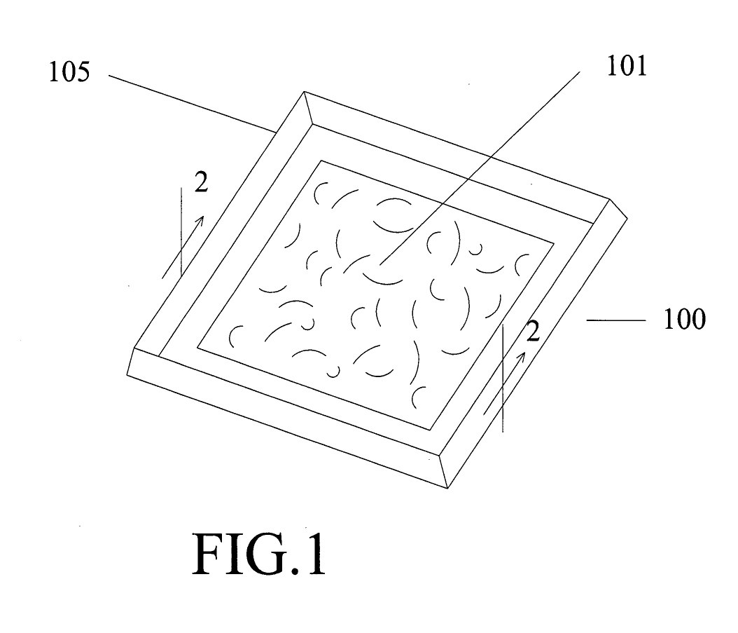

FIG. 1 shows a perspective illustration of the filter, generally referred to as 100. The filter 100 comprises a planar panel of filter medium, 101, which is delimited to all sides by the surrounding periphery 102. The surrounding periphery of the filter medium is held within the filter frame 105.

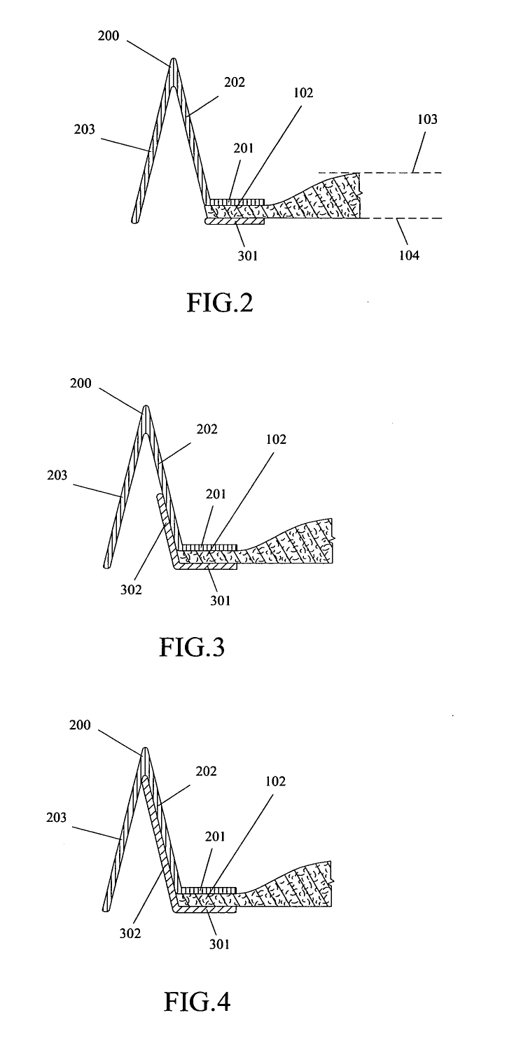

FIG. 2 shows a cross-sectional view of the filter in FIG. 1 along the line 2-2.

The filter panel 101 has a substantially uniform thickness with two opposing major faces, 103 and 104.

The filter frame 105 consists of one upper frame portion 200 and one lower frame portion 300. The first leg of the upper frame portion 201 and the first leg of the lower frame portion 301 form an overlapping sandwich composite with the surrounding periphery of the filter medium 102 in a clamp-like action. This clamp-like action is for example achieved by means of adhesion, friction, bonding, stapling, or other suitable engagement mechanism. Alternatively, the lower frame portion 300 and its first leg 301 may be eliminated and the filter medium is attached to the first leg of the upper frame portion via adhesion, stapling, or other suitable attachment mechanism.

From the first leg 201, the upper frame portion 200 extends outwardly from the filter panel periphery 102 with a second and third leg 202 and 203. The second and third leg of the upper frame portion 202 and 203 are angled to each other at less than 90 degrees, essentially forming a V-shape (flipped vertically with respect to the page). This cross-sectional frame shape allows the nesting of multiple frames and therefore filters in vertical direction. The lower frame portion 300 consists of a first leg 301 only. The upper frame portion is preferably made out of sturdy sheet material, to provide for sufficient rigidity of the filter frame. The lower frame portion 300 may be of a different material, different material strength, stiffness or thickness.

FIGS. 3 and 4 show design variations of the filter frame 105. In these preferred embodiments, the shape of the frame 105 is essentially the same as in FIG. 2, except the lower frame portion 200 consists of a first leg 301 and a second leg 302. The second leg 302 may be a partial leg only as shown in FIG. 3, or a full leg as shown in FIG. 4. The filter panel 101 is sandwich-like attached between the first legs of the upper and lower frame portion, 201 and 301. The second legs of the upper and the lower frame portion 202 and 203 intimately adhere to each other throughout their lengths.

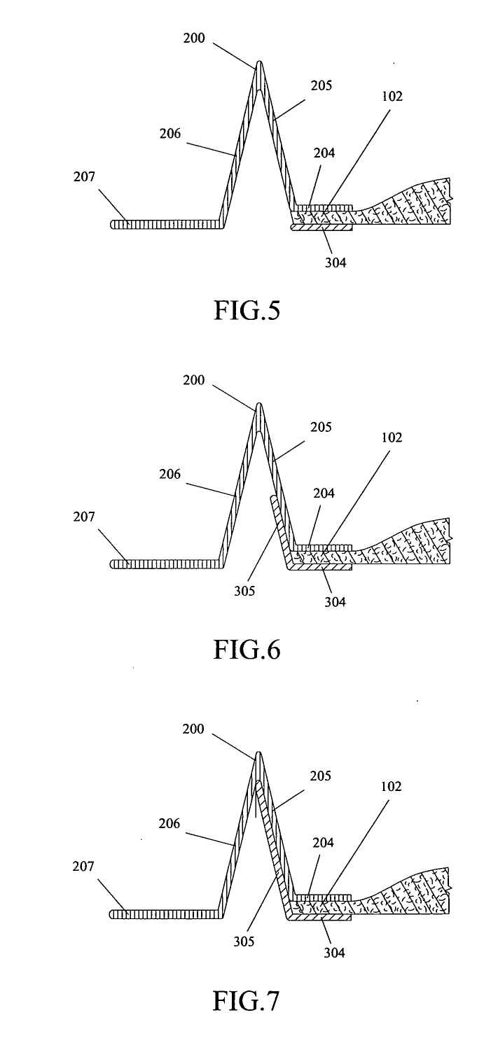

FIG. 5 shows another design variation of the filter frame 105. The first leg of the upper frame portion 204 and the first leg of the lower frame portion 304 form an overlapping sandwich composite with the surrounding periphery of the filter medium 102 in a clamp-like action. This clamp-like action is for example achieved by means of adhesion, friction or bonding.

From the first leg 204, the upper frame portion 200 extends outwardly from the filter panel periphery 102 with a second, third and fourth legs 205, 206 and 207. The second and third leg of the upper frame portion 206 and 207 are angled to each other at less than 90 degrees, essentially forming a vertically flipped V. The fourth leg of the upper frame portion 207 forms a preferably horizontal extension of the third leg of the upper frame portion 206 for increased frame rigidity. The lower frame portion 300 consists of a first leg 301 only.

FIGS. 6 and 7 show variations of the design in FIG. 5. In these embodiments, the shape of the frame 105 is essentially the same as in FIG. 5, except the lower frame portion 200 consists of a first leg 304 and a second leg 305. The second leg 305 may be a partial leg only as shown in FIG. 6, or a full leg as shown in FIG. 7. The filter panel 101 is sandwich-like attached between the first legs of the upper and lower frame portion, 204 and 304. The second legs of the upper and the lower frame portion 205 and 305 intimately adhere to each other throughout their lengths.

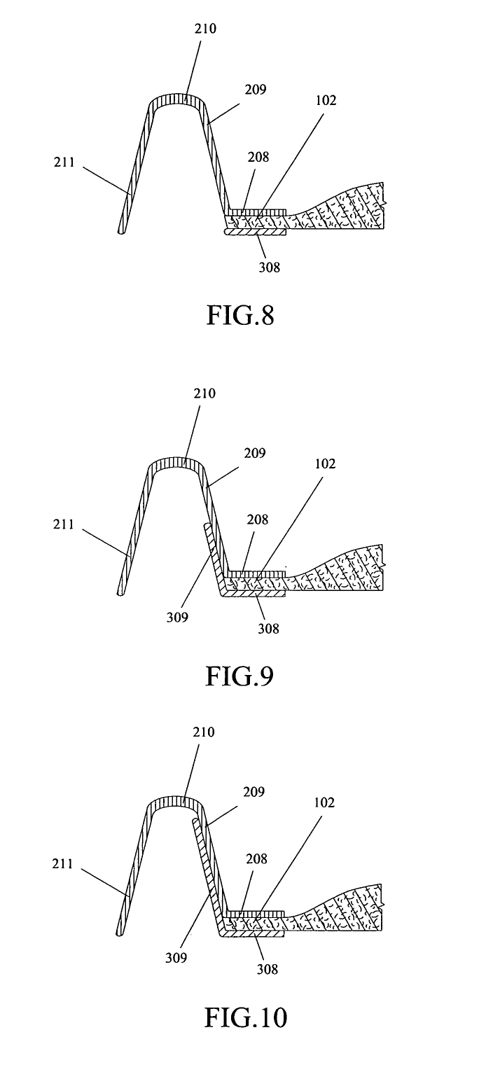

FIG. 8 shows yet another design variation of the filter frame 105. In this embodiment, the V-shape of the frame 105 in FIG. 2 is altered by inserting an additional curved frame leg 210 between the legs 209 and 211 of the in the upper frame portion. As with the design in FIG. 2, the first leg of the upper frame portion 208 and the first leg of the lower frame portion 308 form an overlapping sandwich composite with the surrounding periphery of the filter medium 102 in a clamp-like action.

In FIG. 8 through 10, the first legs of upper and lower frame portion are denoted as 208 and 308. In FIGS. 9 and 10, the lower frame portion is extended by a second leg 309, which may be a partial leg as shown in FIG. 9 or a full leg as shown in FIG. 10. The second legs of the upper and the lower frame portion 208 and 308 intimately adhere to each other throughout their lengths.

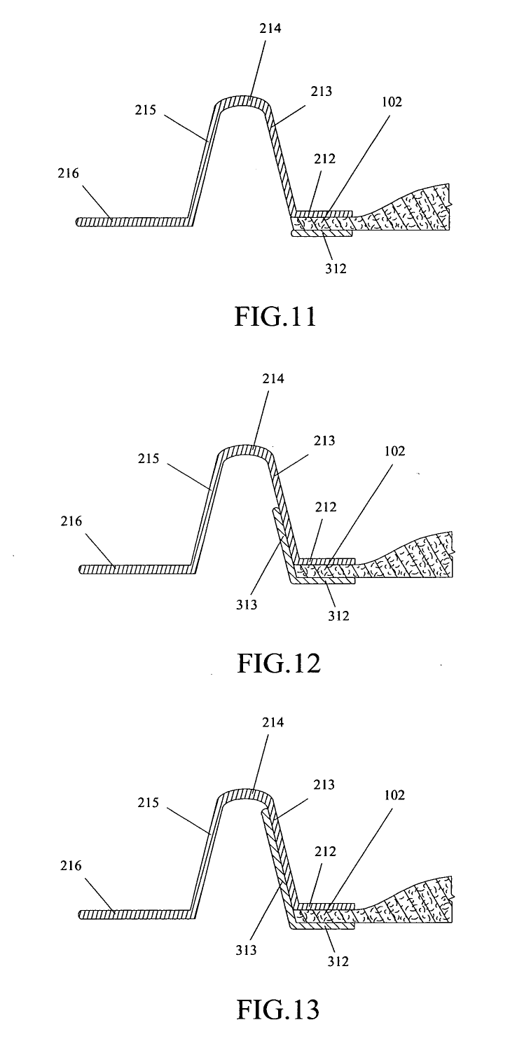

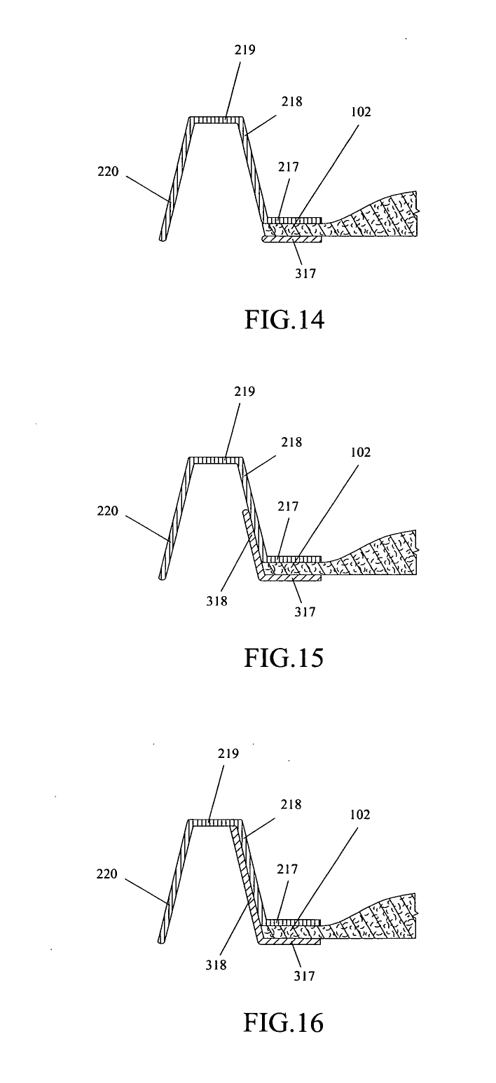

FIG. 11 through 13 show design variations of FIG. 8 through 10, with an additional fifth, preferably horizontal, leg in the upper frame portion, 216, for enhanced frame rigidity. In FIG. 11 through 13, the first legs of the upper and lower frame portion are denoted as 212 and 312, the second legs are denoted as 213 and 313 and the fourth and fifth leg of the upper frame portion are denoted as 215 and 216.

FIG. 14 shows yet another design variation of the filter frame 105. In this preferred embodiment, the horizontally mirrored V-shape of the frame 105 in FIG. 2 is widened by inserting an additional straight, preferably horizontal, frame leg 219 between the legs 218 and 220 of the upper frame portion. As with the design in FIG. 2, the first leg of the upper frame portion 217 and the first leg of the lower frame portion 317 form an overlapping sandwich composite with the surrounding periphery of the filter medium 102 in a clamp-like action.

In FIG. 14 through 16, the first legs of upper and lower frame portion are denoted as 217 and 317. In FIGS. 15 and 16, the lower frame portion is extended by a second leg 318, which may be a partial leg as shown in FIG. 15 or a full leg as shown in FIG. 16. The second legs of the upper and the lower frame portion, 218 and 318, intimately adhere to each other throughout their lengths.

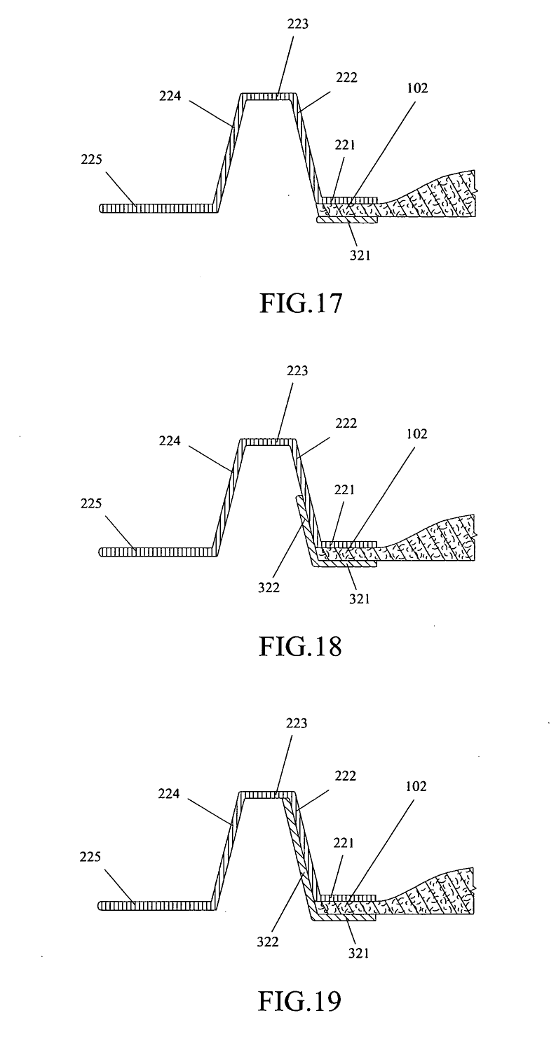

FIG. 17 through 19 show design variations of FIG. 14 through 16, with an additional fifth, preferably horizontal, leg in the upper frame portion, 225, for enhanced frame rigidity. In FIG. 17 through 19, the first legs of the upper and lower frame portion are denoted as 221 and 321, the second legs are denoted as 222 and 322 and the fourth and fifth leg of the upper frame portion are denoted as 223 and 224.

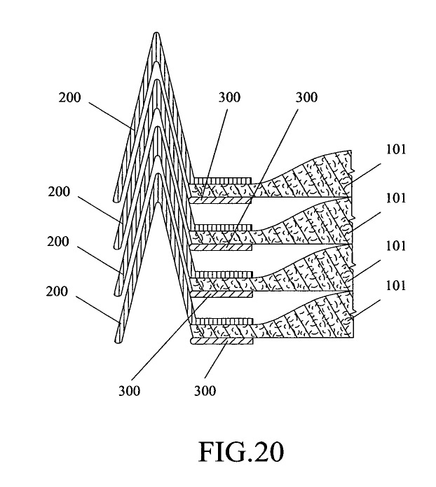

FIG. 20 shows by example of the frame design of FIG. 2 how multiple filters can be stacked normal to the filter panel plane, referred to as vertically, and nested in such a way that they take significantly less space vertically than the same number of filters would take if they were not nested, but stacked on top of each other.

Certain modifications and improvements will occur to those skilled in the art upon a reading of the foregoing description. All modifications and improvements have been deleted herein for the sake of conciseness and readability but are properly within the scope of the following claims.

What is claimed is:

1. A filter comprising:
a. a filter medium having at least one peripheral edge; and
b. a frame member surrounding the at least one peripheral edge of the filter medium panel, the frame member having a cross-section comprising:
i. an upper frame portion;
ii. wherein the upper frame portion comprises a first leg, a second leg extending at an obtuse angle from the first leg, and a third leg extending at an angle from the second leg such that the second and third legs form a V-shape;
iii. wherein the first leg of the upper frame portion engages the at least one peripheral edge of the filter medium.

2. The filter of claim 1, wherein the frame member further comprises a lower frame portion that comprises a first leg, wherein the first leg of the lower frame portion is substantially parallel to the first leg of the upper frame portion and positioned to engage the at least one peripheral edge of the filter medium opposite the first leg of the upper frame portion.

3. The filter of claim 2, wherein the lower frame portion further comprises a second leg extending at an obtuse angle from the first leg and abutting the upper frame portion's second leg.

4. The filter of claim 3, wherein the second leg of the lower frame portion abuts substantially all of the upper frame portion's second leg.

5. The filter of claim 1, wherein the first leg of the upper frame portion engages the at least one peripheral edge of the filter medium with an engagement means selected from the group consisting of an adhesive and at least one staple.

6. The filter of claim 2, wherein the first legs of the upper and lower frame portions engage the at least one peripheral edge of the filter medium with an engagement means selected from the group consisting of a clamping force and a friction force.

7. The filter of claim 1, wherein the upper frame portion further comprises a fourth leg extending from the third leg of the upper frame portion.

8. A filter comprising:
a. a filter medium having at least one peripheral edge; and
b. a frame member surrounding the at least one peripheral edge of the filter medium panel, the frame member having a cross-section comprising:
i. an upper frame portion;
ii. wherein the upper frame portion comprises a first leg, a second leg extending at an obtuse angle from the first leg, a spacing leg extending from the second leg, and a third leg extending from the spacing leg and oriented at an angle to the second leg such that the second, third, and spacing legs permit nesting;
iii. wherein the first leg of the upper frame portion engages the at least one peripheral edge of the filter medium.

9. The filter of frame 8, wherein the spacing leg is substantially straight.

10. The filter of frame 8, wherein the spacing leg is curved.

11. The filter of claim 8, wherein the frame member further comprises a lower frame portion that comprises a first leg, wherein the first leg of the lower frame portion is substantially parallel to the first leg of the upper frame portion and positioned to engage the at least one peripheral edge of the filter medium opposite the first leg of the upper frame portion.

12. The filter of claim 11, wherein the lower frame portion further comprises a second leg extending at an obtuse angle from the first leg and abutting the upper frame portion's second leg.

13. The filter of claim 12, wherein the second leg of the lower frame portion abuts substantially all of the upper frame portion's second leg.

14. The filter of claim 8, wherein the first leg of the upper frame portion engages the at least one peripheral edge of the filter medium with an engagement means selected from the group consisting of an adhesive and at least one staple.

15. The filter of claim 11, wherein the first legs of the upper and lower frame portions engage the at least one peripheral edge of the filter medium with an engagement means selected from the group consisting of a clamping force and a friction force.

16. The filter of claim 8, wherein the upper frame portion further comprises a fourth leg extending from the third leg of the upper frame portion.
